(19) United States
(12) Patent Application Publication
(10) Pub. No.: US 2010/0002924 A1
(43) Pub. Date: Jan. 7, 2010

(54) Versatile Single Photon Emission Computed Tomography And Imaging Methods Using The Same

(75) Inventors: Sey Joon Park, Suwonsi (KR); Yong Kown Kim, Nonsansi (KR); Yong Choi, Seoul (KR); Ki Sung Lee, Yonginsi (KR); Hyoung Uk Choi, Sungnamsi (KR)

Correspondence Address: REINHART BOERNER VAN DEUREN P.C., 2215 PERRYGREEN WAY, ROCKFORD, IL, 61107, US

(73) Assignee: Nucare Medical Systems, Inc., Seoul (KR)

(21) Appl. No.: 12/262,880

(22) Filed: Oct. 31, 2008

(30) Foreign Application Priority Data
Jul. 3, 2008 (KR) 2008-0064343

(51) Int. Cl. G06K 9/00; H05G 1/60

(52) U.S. Cl. 382/131; 378/4

(57) ABSTRACT

Disclosed is a versatile single photon emission computerized tomograph capable of imaging a number of areas of the patient by the same system to obtain diagnostic nuclear medical images of excellent resolution and sensitivity, and imaging method using the same. The versatile single photon emission computerized tomograph includes a support means configured in a plate structure so that the patient can lie down and adapted to move in longitudinal and vertical directions while the patient is lying down; a gantry configured in an arc shape about an object to be imaged; a body for retaining and supporting an outer surface of the gantry while being able to slide and rotate; and at least one detector mounted so as to slide along the inner surface of the gantry and adapted to protract toward or retract from the center point of the gantry to image an organ of the patient.

### CROSS-REFERENCE TO RELATED PATENT APPLICATIONS

This patent application claims the benefit of Korean Patent Application No. 2008-0064343, filed Jul. 3, 2008, the entire teachings and disclosure of which are incorporated herein by reference thereto.

### BACKGROUND OF THE INVENTION

1. Field of the invention

The present invention relates to a versatile single photon emission computerized tomograph for diagnostic nuclear medical imaging and an imaging method using the same. More particularly, the present invention relates to a versatile single photon emission computerized tomograph having a gantry of a novel design so that various organs can be imaged closely by a single system, and a driving device installed on the body to endow the tomograph with mobility (i.e. it can be moved and used in an emergency or operating room), as well as an imaging method using the same.

2. Description of the Prior Art

As generally known in the art, a single photon emission computerized tomograph refers to a device for obtaining sectional images of a living body by receiving images of radiocontrast agents, which are distributed in the body, from multiple directions and computerizing them.

Conventional single photon emission computerized tomographs have structural problems such as bulky and heavy detectors placing many restrictions on the gantry design and severely limiting the installation space. In addition, the fact that the center of rotation of the device is in the patient's body makes it difficult to bring the detector close to the target organ, and degrades image quality.

Recently, detectors have been tending to become smaller, thinner, and lighter in line with development of related technology and the request of the nuclear medicine market for systems for imaging specific organs. However, if a smaller detector is moved along a trajectory of rotation about the center of the patient's body, the effective field of view is inevitably clipped when the target organ is imaged. In the case of a cardiac imaging device, for example, the detector needs to be larger than the target organ to prevent the effective field of view from being clipped.

In addition, the fact that the bed on which the patient lies down during imaging is fixed makes it difficult to change the posture and image the patient's body in various positions.

### SUMMARY OF THE INVENTION

Accordingly, the present invention has been made to solve the above-mentioned problems occurring in the prior art, and the present invention provides a single photon emission computed tomograph adapted to make the detector small while improving resolution and sensitivity.

The present invention also provides a single photon emission computerized tomograph adapted to easily change the posture or position of the patient so that the desired part can be imaged easily.

In accordance with an aspect of the present invention, there is provided a versatile single photon emission computerized tomograph, as well as an imaging method using the same. The versatile single photon emission computerized tomograph includes a support means configured in a plate structure so that a patient can lie down and adapted to move in longitudinal and vertical directions while the patient is lying down; a gantry configured in an arc shape about an object to be imaged; a body for retaining and supporting an outer surface of the gantry while being able to slide and rotate; and at least one detector mounted so as to slide along the inner surface of the gantry and adapted to protract toward or retract from a center point of the gantry to image an organ of the patient.

The versatile single photon emission computerized tomograph according to the present invention is advantageous in that, when the detector moves along a trajectory of rotation about a target organ to image it, the detector is brought as close as possible to the patient's body and is rotated along the organ. This means that a small field of view is enough to image the target organ. This guarantees a compact structure.

In addition, the gantry structure can be operated in a simple manner according to the position of the target organ to change the posture and position of the patient. Therefore, various organs can be imaged efficiently.

The driving device mounted on the body makes it possible to move the equipment to a ward, an emergency room, or an operating room so that single equipment is available for multiple purposes.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a versatile single photon emission computerized tomograph according to a first exemplary embodiment of the present invention;

FIG. 2 is a perspective view of the versatile single photon emission computerized tomograph when the support means is operated;

FIG. 3 is a lateral view of the single photon emission computerized tomograph;

FIG. 4 shows the versatile single photon emission computerized tomograph during imaging;

FIG. 5 is a perspective view of the versatile single photon emission computerized tomograph when the gantry is rotated;

FIG. 6 briefly shows the versatile single photon emission computerized tomograph when imaging the thorax; and

FIG. 7 briefly shows the versatile single photon emission computerized tomograph when imaging the entire body.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components, and so repetition of the description on the same or similar components will be omitted.

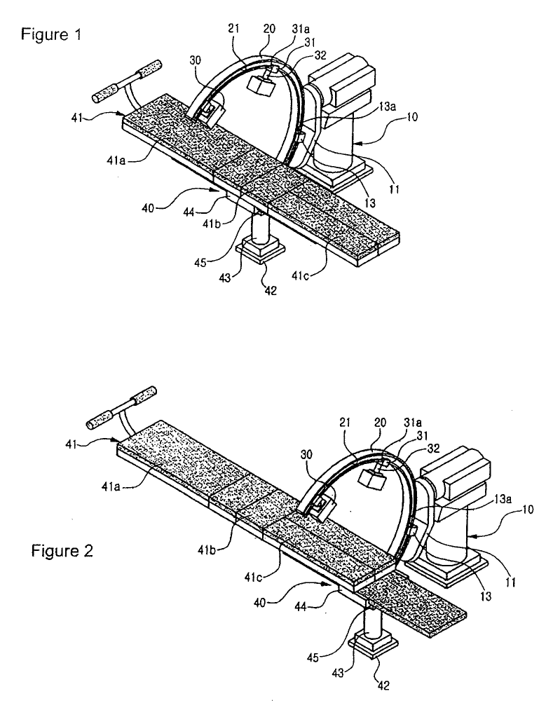

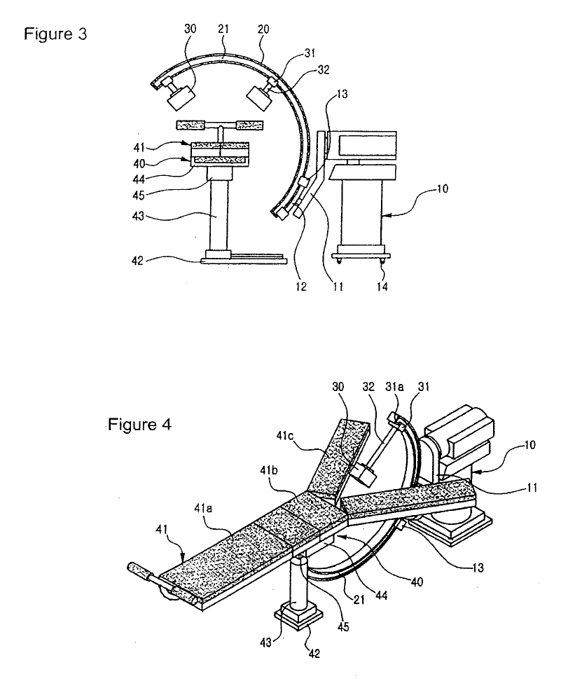

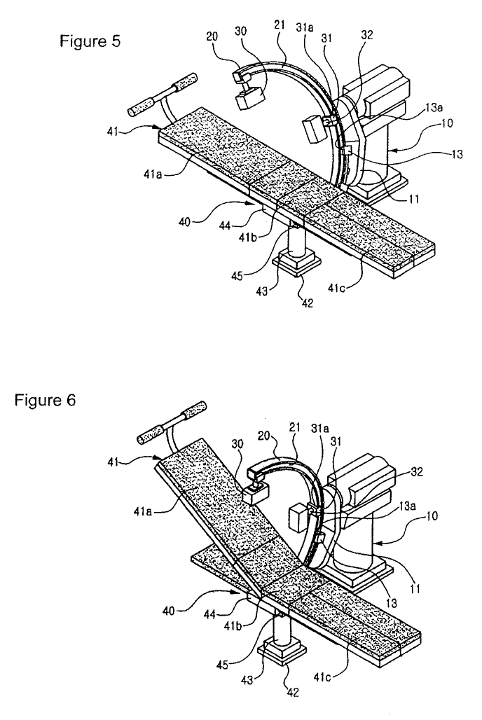

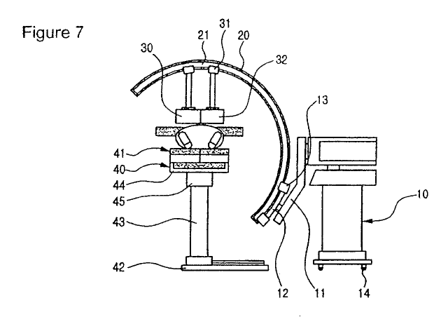

FIG. 1 is a perspective view of a versatile single photon emission computerized tomograph according to a first exemplary embodiment of the present invention. FIG. 2 is a perspective view of the versatile single photon emission computerized tomograph when the support means is operated. FIG. 3 is a lateral view of the single photon emission computerized tomograph. FIG. 4 shows the versatile single photon emission computerized tomograph during imaging. FIG. 5 is a perspective view of the versatile single photon emission computerized tomograph when the gantry is rotated. FIG. 6 briefly shows the versatile single photon emission computerized tomograph when imaging the thorax. FIG. 7 shows the versatile single photon emission computerized tomograph when imaging the entire body.

As shown, the single photon emission computerized tomograph includes a body 10, a gantry 20 mounted on the body 10 and configured in an arc shape about the imaging target, a detector 80 adapted to slide along the arc-shaped portion of the gantry 20 and protract to or retract from the center of the gantry to image the patient's organ, and a support means 40 configured in a flat plate structure so that the patient can lie or sit down and adapted to translate and rotate in the longitudinal and vertical directions, respectively, while the patient is lying down. The arc-shaped gantry 20 is not necessarily circular, but may be elliptical, etc.

The body 10 has a support post and wheels 14 installed on four corners of the bottom, respectively, so that it can be moved easily. The body 10 includes a retaining beam 11, a retaining member 12, and engaging members 13. Particularly, the retaining beam 11 protrudes from one side of the body by a predetermined length, and is retained on the body while being able to rotate. The retaining beam 11 is preferably shaped to surround the arc-shaped portion of the outer peripheral surface of the gantry 20. The central area of the retaining member 12 is coupled to an end of the retaining beam 11, and the engaging members 13 are mounted on both ends of the retaining member 12. Engaging ledges 13a protrude from the protruding end of each engaging member 13 up to a predetermined height, and are bent toward each other. Besides the above-mentioned structure of rotatably retaining the retaining beam 11 on the body, it is also possible to rotatably couple the central area of the retaining member 12 to an end of the retaining beam 11.

The gantry 20 of an arc shape has sliding recesses 21 formed on both lateral surfaces at a predetermined depth while extending along both lateral surfaces in an arc shape. The engaging members 13 are mounted on the outer peripheral surface of the gantry 20 and are adapted to slide while maintaining the contact. Particularly, the engaging ledges 13a, which protrude to be inserted into respective sliding recesses 21, are fitted into the corresponding sliding recesses 21 and slide therein.

The detector 30 has a detector module installed therein so that organs can be imaged. The detector 30 is supported on one end of a support post 32, which rotatably supports the detector and which is adapted to protract and retract. An engaging member 31 is mounted on the other end of the support post 32. When a number of detectors 30 are mounted, they are adapted to be driven independently.

The detector module is equipped with various types of collimators in a releasable manner according to the imaging purpose. Among gamma rays emitted from the living body, the collimators transmit gammy rays having the same direction as the detector, and block those coming from other directions. In other words, the collimators place a geometric restriction so that gamma rays emitted from the necessary part are solely incident on the detector. Thus, it can be said that the collimators act as focusing lenses for the detector 30. Collimators are generally made of lead to block radioactive rays, and include pinhole collimators, diverging collimators, converging collimators, parallel-hole collimators, pan-beam collimators, and cone-beam collimators. According to the desired usage and imaging target, suitable collimators are attached and used.

Pinhole collimators are made of lead in a hollow conical shape, and have a small hole on the sharp end. They have excellent resolution, but poor sensitivity, and are generally used to inspect a small area, such as the thyroid gland.

The converging collimators are adapted to magnify a small area, and have excellent resolution but poor sensitivity.

The diverging collimators are used to detect a large area by a small detector, and have poor resolution but excellent sensitivity.

Parallel-hole collimators generally have a large number of parallel holes in a hexagonal structure, and their resolution and sensitivity can be adjusted according to the size and height of the parallel holes. Pan-beam collimators have the shape of pans, and can magnify and image the target area of an object according to the distance between the original point of the object and the detector.

Collimators of various shapes and usages, including pinhole collimators and parallel-hole collimators, are mounted. The engaging member 31 has engaging ledges 31a, which protrude up to a predetermined height from a lateral surface and which are bent toward each other, so that the engaging member 31 can be mounted and slide on the inner surface of the gantry 20. The engaging ledges 31a are fitted into the sliding recesses 21 formed on both lateral surfaces of the gantry 20, and are retained therein while being able to slide. The engaging ledges 31a connected to the detector 30 are adapted to contact the engaging ledges 13a of the engaging member 13 connected to the retaining member 12 during sliding.

The structure for mounting the engaging member 31 on the gantry 20 is not limited to the above example (i.e. the engaging ledges 31a engage with the sliding recesses 21), but any structure can be adopted as long as the engaging members 31 are coupled to slide along the gantry 20. Particularly, the sliding recess 21 may be formed on only one lateral surface (not on both lateral surfaces), and the engaging member 31 has a protrusion coupled so as to slide inside the sliding recess. In addition, the area of slidable coupling between the gantry 20 and the engaging member 13 is not limited to the above structure.

The support means 40 includes a bottom plate 42 of a flat plate shape to be placed on the floor, an elevating post 43 vertically placed on the bottom plate 42 and adapted to move upward/downward in the longitudinal direction, a sliding base 44 fixedly mounted on an end of the elevating post 43, and a bed 41 coupled to the sliding base 44 and adapted to slide thereon.

The bed 41 includes a middle portion 41b for supporting the patient's hip, an upper portion 41a hinge-coupled to one side of the middle portion 41b while allowing angle adjustment so that the patient's bust can be supported, and a lower portion 41c coupled to the other end of the middle portion 41b to support the patient's legs. The lower portion 41c is preferably divided into left and right portions, which are coupled to the middle portion 41b and adapted to rotate in opposite directions, so that the patient's legs can be spread or brought close to each other while being supported thereon. The bed 41 is preferably designed to be thin and light by using a substance, which has a low density and which can sufficiently bear the patient's weight, to minimize the attenuation effect of gamma energy caused by the bed 41 during imaging.

A rotation member 45 is additionally mounted at the junction between the sliding base 44 and the elevating post 43 so that the sliding base 44 and the bed 41 can rotate with regard to the elevating post 43.

The process of operating the versatile single photon emission computerized tomograph according to an exemplary embodiment of the present invention, which has the above-mentioned construction, will now be described.

Firstly, the center point of the organ to be imaged is brought into coincidence with that of the gantry arc by moving the gantry 20 and the body 10 or by operating the support means 40.

The patient lies on the bed 41, and according to the position of the organ to be imaged, the upper portion 41a is rotated to set the posture of the patient (i.e. sitting obliquely or lying flat). The lower portion 41c is similarly operated to maintain the necessary posture. The sliding base 44 or the elevating post 43 is then operated to bring the arc center of the gantry 20 into coincidence with the center point of the organ to be imaged.

The retaining beam 11 connected to the body 10 is then rotated to tilt the gantry 20 at a predetermined angle, as shown in FIG. 5. Alternatively, the gantry 20 slidably coupled to the engaging members 13 formed on both ends of the retaining member 12 is slid, as shown in FIG. 4, to determine the rotation trajectory that can be used for imaging.

The detector 30, which is coupled to slide along the inner surface of the gantry 20, is operated successively to image the target organ. The imaging process using the detector 30 will be described in more detail. The engaging member 31 is positioned for initial imaging, and the support post 32 is protracted so that the detector 30 comes as close as possible to the patient's body. Imaging begins, and after the imaging is over, the support post 32 is retracted so that the detector 30 can move to the next position. In addition, the engaging member 31 is slid to the next position along the gantry 20. These steps are conducted successively to complete the imaging.

As such, the versatile single photon emission computerized tomograph according to the present invention is advantageous in that, since the detector 30 moves about the organ to be imaged, images are not clipped even if a compact detector 10 having a small field of view is used. In addition, the fact that the detector is brought as close as possible to the target organ during imaging ensures excellent resolution and improved sensitivity.

The bed 41 can be deformed according to the position of the organ to be imaged so that the patient's posture can be easily changed. This improves the efficiency of the imaging process. In addition, the center point of the organ to be imaged can be automatically brought into coincidence with the arc center point of the gantry 20 by operating the support means 40 or the gantry 20. This improves the operation efficiency.

Furthermore, a specific organ of the patient (e.g. entire body, heart, brain, joint, prostate, breasts, thyroid, liver, kidneys) can be imaged by changing the patient's posture or by driving the device. The method for imaging each portion of the body of the subject (i.e. patient) will now be described in more detail.

The method for imaging the target area of the subject by the single photon emission computerized tomograph proceeds as follows: the subject is positioned flat on the bed 41 constituting the support means 40 in a preparation step; the device operator adjusts the inspection mode of the system to conform to a scan type suitable for the target area in a scan operation step; the gantry 20 is aligned to a position suitable for imaging in an alignment step; the detector 30 is moved along the gantry 20 and brought close to the target area in a movement step; inspection is conducted while moving the detector 30 along the gantry 20 by a predetermined angle in an inspection step; and the detector 30 and the gantry 20 return to the original conditions so that the subject can move after the imaging for inspection is completed in a returning step. A collimator suitable for the area to be imaged is mounted inside the detector 30.

More particularly, when the brain is to be inspected, a brain scan type is selected as the scan type in the scan operation step. The gantry 20 is aligned perpendicular to the longitudinal direction of the bed 41 in the alignment step. The detector 30 is moved by a predetermined angle along the gantry 20 while maintaining the detector 30 perpendicular to the brain in the movement step. Imaging then proceeds.

When the thorax (e.g. heart) is to be imaged, the upper portion 41a of the bed 41 is lifted by a predetermined angle so that the subject can sit obliquely in the preparation step, as shown in FIG. 6. A thorax scan type is selected as the scan type in the scan operation step. The gantry 20 is aligned perpendicular to the longitudinal direction of the bed 41 in the alignment step. The detector 30 is moved by a predetermined angle along the gantry 20 while maintaining the detector 30 perpendicular to the organ to be imaged (e.g. heart, thorax) in the movement step. Considering that the thorax is not perfectly circular, the length of the protracted detector 30 is adjusted as it moves along the gantry 20.

When the prostate is to be imaged, as shown in FIG. 4, a prostate scan type is selected as the scan type in the scan operation step, and the lower portion 41 c is unfolded so that the subject's legs remain spread. The gantry 20 is aligned perpendicular to the bed 41 in the alignment step. The detector 30 is moved by a predetermined angle along the gantry 20 while maintaining the detector 30 perpendicular to the prostate to be imaged in the movement step. Imaging then proceeds.

When a joint (e.g. knee) is to be imaged, a joint scan type is selected as the scan type in the scan operation step. The gantry 20 is moved and rotated so that the joint is properly positioned in the alignment step. The detector 30 is moved by a predetermined angle along the gantry 20 while maintaining the detector 30 perpendicular to the joint to be imaged in the movement step. Imaging then proceeds.

When the entire body of the subject is to be imaged, as shown in FIG. 7, the subject lies flat on the bed 41 in the preparation step; the device operator adjusts the inspection mode of the system to conform to an entire body scan type, which is suitable for entire body imaging, in the scan operation step; the gantry 20 is aligned perpendicular to the longitudinal direction of the bed 41 so that the entire body can be imaged in the alignment step; two detectors 30 are positioned horizontally and are protracted so that they come close to the imaging target in the movement step; the bed 41 is moved in the longitudinal direction throughout the entire body of the subject, as well as in a section of the body, to conduct inspection in the inspection step; and the detectors 30 and the gantry 20 return to original conditions so that the subject can move after the imaging for inspection is completed in the returning step.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A versatile single photon emission computerized tomograph comprising:
a support means configured in a plate structure so that a patient can lie down and adapted to move in longitudinal and vertical directions while the patient is lying down;
a gantry configured in an arc shape about an object to be imaged;
a body for retaining and supporting an outer surface of the gantry while being able to slide and rotate; and
at least one detector mounted so as to slide along the inner surface of the gantry and adapted to protract toward or retract from a center point of the gantry to image an organ of the patient.

2. The versatile single photon emission computerized tomograph as claimed in claim 1, wherein the support means comprises a bed comprising:
a middle portion for supporting a hip portion of the patient;
an upper portion hinge-coupled to a first side of the middle portion while allowing angle adjustment to support a bust of the patient; and
a lower portion coupled to a second side of the middle portion so that legs of the patient can be supported.

3. The versatile single photon emission computerized tomograph as claimed in claim 2, wherein the lower portion is divided into left and right portions rotatably coupled to the middle portion so that legs of the patient can be spread while being supported.

4. The versatile single photon emission computerized tomograph as claimed in claim 1, wherein a collimator selected from the group consisting of a pinhole collimator, a diverging collimator, a converging collimator, a parallel-hole collimator, a pan-beam collimator, and a cone-beam collimator is mounted on the detector.

5. The versatile single photon emission computerized tomograph as claimed in claim 2, wherein the support means comprises:
a bottom plate of a flat plate shape placed on a floor;
an elevating post erected on the bottom plate and adapted to move upward or downward in a longitudinal direction; and
a sliding base placed on an end of the elevating post to support a bottom surface of the bed while being able to slide in the longitudinal direction.

6. The versatile single photon emission computerized tomograph as claimed in claim 4, wherein the support means comprises:
a bottom plate of a flat plate shape placed on a floor;
an elevating post erected on the bottom plate and adapted to move upward or downward in a longitudinal direction; and
a sliding base placed on an end of the elevating post to support a bottom surface of the bed while being able to slide in the longitudinal direction.

7. The versatile single photon emission computerized tomograph as claimed in claim 5, wherein the bottom plate is integrally connected to the body, and the sliding base has a rotation member so that the bed can be rotated with regard to the elevating post.

8. The versatile single photon emission computerized tomograph as claimed in claim 1, wherein the gantry has sliding recesses formed on both lateral surfaces at a predetermined depth so as to extend along both lateral surfaces in an arc shape, and the detector and the body have engaging ledges slidably fitted to the sliding recesses, respectively.

9. The versatile single photon emission computerized tomograph as claimed in claim 2, wherein the gantry has sliding recesses formed on both lateral surfaces at a predetermined depth so as to extend along both lateral surfaces in an arc shape, and the detector and the body have engaging ledges slidably fitted to the sliding recesses, respectively.

10. The versatile single photon emission computerized tomograph as claimed in claim 3, wherein the gantry has sliding recesses formed on both lateral surfaces at a predetermined depth so as to extend along both lateral surfaces in an arc shape, and the detector and the body have engaging ledges slidably fitted to the sliding recesses, respectively.

11. The versatile single photon emission computerized tomograph as claimed in claim 4, wherein the gantry has sliding recesses formed on both lateral surfaces at a predetermined depth so as to extend along both lateral surfaces in an arc shape, and the detector and the body have engaging ledges slidably fitted to the sliding recesses, respectively.

12. The versatile single photon emission computerized tomograph as claimed in claim 8, wherein the detector is supported on a first end of a support post for supporting the detector so that the detector can rotate and protract or retract, and an engaging member is mounted on a second end of the support post, the engaging ledge being formed on the engaging member.

13. The versatile single photon emission computerized tomograph as claimed in claim 12, wherein, when a number of detectors are mounted, respective detectors are driven independently.

14. The versatile single photon emission computerized tomograph as claimed in claim 8, wherein the body has a retaining member protruding along the gantry by a predetermined length, the retaining member having at least one engaging ledge.

15. The versatile single photon emission computerized tomograph as claimed in claim 14, wherein the retaining beam has an end rotatably retained on the body.

16. The versatile single photon emission computerized tomograph as claimed in claim 1, wherein the body has a number of wheels mounted on a bottom surface so that the body can be moved easily.

17. A method for imaging and inspecting an imaging target of a subject by the versatile single photon emission computerized tomograph, the method comprising the steps of:
positioning the subject flat on the bed constituting the support means;
adjusting a system inspection mode to a scan type suitable for the imaging target by a device operator;
aligning the gantry to a position suitable for imaging;
moving the detector along the gantry to come close to the imaging target;
conducting inspection while moving the detector along the gantry by a predetermined angle; and
returning the detector and the gantry to original conditions so that the subject can move after imaging for inspection is completed.

18. The method as claimed in claim 17, wherein, when the imaging target is a brain, a brain scan type is selected as the scan type in the adjusting step, the gantry is aligned perpendicular to the bed in the aligning step, and the detector is moved along the gantry while remaining perpendicular to the brain in the moving step.

19. The method as claimed in claim 17, wherein, when the imaging target is a thorax, the bed is adjusted so that the subject can remain seated obliquely in the positioning step, a thorax scan type is selected as the scan type in the adjusting step, the gantry is aligned perpendicular to the bed in the aligning step, and the detector is moved along the gantry while remaining perpendicular to the thorax in the moving step, a length of protraction of the detector being adjusted to confirm to a non-circular shape of the thorax.

20. The method as claimed in claim 17, wherein, when the imaging target is a prostate, a prostate scan type is selected as the scan type in the adjusting step, the bed is adjusted so that the subject can maintain legs spread, the gantry is aligned perpendicular to the bed in the aligning step, and the detector is moved along the gantry while remaining perpendicular and close to the prostate in the moving step.

21. The method as claimed in claim 17, wherein, when the imaging target is a joint, a joint scan type is selected as the scan type in the adjusting step, the gantry is moved and rotated to a position suitable for joint scan in the aligning step, and the detector is moved along the gantry while remaining perpendicular and close to the joint in the moving step.

22. A method for imaging and inspecting an entire body of a subject by the versatile single photon emission computerized tomograph, the method comprising the steps of:
positioning the subject flat on the bed constituting the support means;
adjusting a system inspection mode to an entire body scan type suitable for entire body imaging by a device operator;
aligning the gantry perpendicular to the bed to be suitable for entire body imaging;
positioning two detectors horizontally and protracting the detectors close to an imaging target;
conducting inspection while moving the bed throughout the entire body of the subject and in a predetermined section of the body; and
returning the detectors and the gantry to original conditions so that the subject can move after imaging for inspection is completed.
